(19) United States
(12) Patent Application Publication
(10) Pub. No.: US 2015/0106354 A1
(43) Pub. Date: Apr. 16, 2015

(54) AUTOMATED COMPOSITION OF TOPICAL MEDIA

(71) Applicant: International Business Machines Corporation, Armonk, NY (US)

(72) Inventors: Gary D. Cudak, Creedmoor, NC (US); Lydia M. Do, Raleigh, NC (US); Christopher J. Hardee, Raleigh, NC (US); Adam Roberts, Moncure, NC (US)

(73) Assignee: International Business Machines Corporation, Armonk, NY (US)

(21) Appl. No.: 14/057,259

(22) Filed: Oct. 18, 2013

Related U.S. Application Data
(63) Continuation of application No. 14/053,820, filed on Oct. 15, 2013.

(51) Int. Cl. G06F 17/30

(52) U.S. Cl. CPC G06F 17/30864; G06F 17/30038
USPC 707/707

(57) ABSTRACT

Embodiments of the present invention provide a method, system and computer program product for the automated composition of topical media. In an embodiment of the invention, a method for the automated composition of topical media is provided. The method includes specifying a topic of interest in a search engine interface of a search engine. The method also includes searching one or more media stores over a computer communications network for media files pertaining to the specified topic and retrieving one or more media files including portions corresponding to the specified topic. Finally, the method includes compositing the portions into a single media file and storing into fixed storage the single media file.

### CROSS-REFERENCE TO RELATED APPLICATIONS

This application claims priority to U.S. patent application Ser. No. 14/053,820, currently pending, filed Oct. 15, 2013, the entirety of which are incorporated herein by reference.

### BACKGROUND OF THE INVENTION

1. Field of the Invention

The present invention relates to the composition of media from multiple different media sources.

2. Description of the Related Art

The advent of the Internet has produced enumerable ways for individuals to seek out and acquire information about virtually anything. Initially, when the Internet primarily served as medium over which academics shared publications and individuals exchanged messages, the development of the World Wide Web resulted in new modes of sharing not just documents, but also other types of media including imagery, audio, and video. Most recently, the maturation of social media has facilitated even more advanced modes of publishing media, and consuming media.

Accessing media files generally requires one to indicate through a search engine, media pertinent to a particular topic. The result set, however, can include a vast selection of links to media of irrelevance to the desired topic. Consequently, the end user is compelled to expend great efforts in seeking out topically relevant media. The use of media specific search engines and repositories can alleviate some of the inconvenience in locating topical media of interest in that at least the result set of a search is limited to a particular type of media—namely video material.

Oftentimes, media pertaining to a particular topic can include several subtopical elements—but not all subtopical elements associated with a desired topic. As a result, one seeking full media coverage of a particular topic is required to locate multiple different topically relevant media files in order to achieve complete coverage of the topic. In doing so, of course, much retrieved material is redundantly present in the different media files. Accordingly, much time is wasted reviewing video material of common subtopics only to access video material containing complete coverage of the topic inclusive of all subtopics.

### BRIEF SUMMARY OF THE INVENTION

Embodiments of the present invention address deficiencies of the art in respect to the retrieval of media inclusive of a specified topic, or of all desired subtopics of a specified topic, and provide a novel and non-obvious method, system and computer program product for the automated composition of topical media. In an embodiment of the invention, a method for the automated composition of topical media is provided. The method includes specifying a topic of interest in a search engine interface of a search engine and, optionally additionally specifying in the search engine interface one or more subtopics of the topic of interest. The method also includes searching one or more media stores over a computer communications network for media files pertaining to the specified topic and retrieving one or more media files including portions corresponding to the specified topic, and optionally, the one or more subtopics. Finally, the method includes compositing the portions into a single media file and storing into fixed storage the single media file.

In one aspect of the embodiment, the portions are sorted according to common subtopic during composition into the single media file. In another aspect of the embodiment, only corresponding portions of a highest rating relative to other corresponding portions are included during composition while corresponding portions of a lowest rating are excluded from composition. In yet another aspect of the embodiment, only media files determined to be popular are retrieved while other media files determined not to be popular are excluded from retrieval. For instance, a media file is determined to be popular based upon frequency of views known for the media file, a frequency of shares for the media file, a frequency of recommends for the media file, or a rating applied to the media file.

In even yet another aspect of the embodiment, only portions known to be of less than a threshold playback duration are included for composition into the single media file. Finally, in a further aspect of the embodiment, the portions of each of the media files are determined to correspond to the one or more subtopics based upon tags applied to the portions of each of the media files. In this regard, the method can include displaying in the search engine interface a list of all subtopics corresponding to each of the media files based upon the tags and specifying the subtopics by selecting in the list the one or more subtopics of interest.

In another embodiment of the invention, a media retrieval data processing system can be configured for the automated composition of topical media. The system can include a host computing system that includes at least one computer with memory and at least one processor. The system also can include a media file search engine executing in the memory of the host computing system and operable to search communicatively linked media stores for media files pertaining to a specified topic. Finally, the system can include an automated composition module coupled to the media file search engine. The module can include program code that when executed in the memory of the host computing system directs the media file search engine to search the media stores for media files pertaining to the specified topic, retrieves by way of the media file search engine one or more media files including portions corresponding to the topic, and optionally one or more subtopics specified for the topic, composites the portions into a single media file, and returns the single media file to a requesting client.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for the automated composition of topical media

FIG. 2 is a schematic illustration of a media retrieval data processing system configured for the automated composition of topical media; and,

FIG. 3 is a flow chart illustrating a process for the automated composition of topical media.

### DETAILED DESCRIPTION OF THE INVENTION

Embodiments of the invention provide for the automated composition of topical media. In accordance with an embodiment of the invention, an end user through a user interface to a search engine can specify a topic and, optionally, one or more subtopics to the topic. Based upon the specified topic (or subtopics), one or more media files can be located over a computer communications network such that the media files include portions corresponding to the specified topic (or subtopics). Thereafter, the included portions of the media files can be compo sited into a single media file and stored for playback by the end user. In this way, comprehensive coverage of different topics (or subtoics of a topic) can be aggregated into a single media file in an automated fashion.

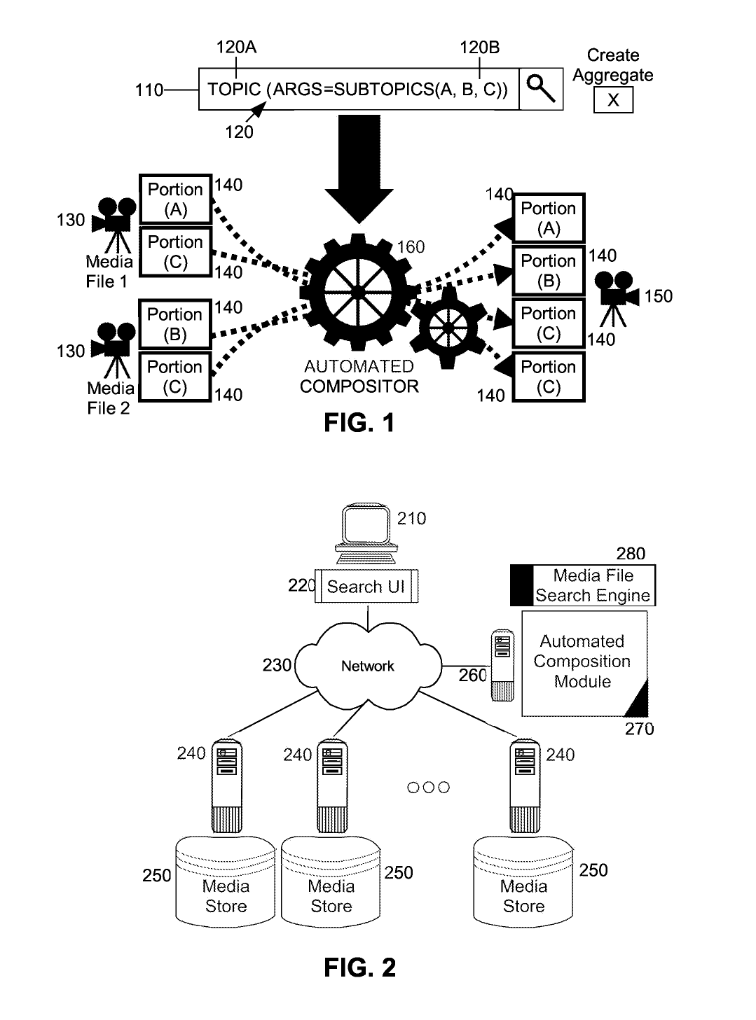

In further illustration, FIG. 1 pictorially shows a process for the automated composition of topical media. As shown in FIG. 1, a search engine interface 110 can receive a search query 120 for media files of a particular topic 120A. Additionally, the query 120 can specify one or more subtopics 120B. The search query 120 can be provided to an automated compositor 160 that can retrieve different media files 130 pertaining to the topic 120A. Thereafter, the automated compositor 160 can create a composite single media file 150 of the different portions 140 of the media files 130, in sorted order, corresponding to the specified subtopics 120B. As a result, comprehensive media file coverage of the specified subtopics 120B of the topic 120A can be aggregated into the single media file 150 in an automated fashion.

The process described in connection with FIG. 1 can be implemented in a media retrieval data processing system. In further illustration, FIG. 2 schematically shows a media retrieval data processing system configured for the automated composition of topical media. The system can include a client computer 210 with memory and at least one processor supporting the operation of a search engine user interface 220. The client computer 210 can be communicatively coupled to a host computing system 260 over computer communications network 230. The host computing system 260 can include one or more computers, each with memory and at least one processor, and can support the execution of an automated composition module 270 of a media file search engine 280.

The media file search engine 280 can be configured to receive a query for media files of a particular topic and, in response thereto, to retrieve from different media stores 250 by way of corresponding host computers 240, media files corresponding to the particular topic of the query. For instance, the media file search engine 280 can consult a previously constructed index of media files in order to identify the media files corresponding to the particular topic of the query and the respective network locations of the identified media files. The automated composition module 270, in turn, can process the media files corresponding to the particular topic of the query in order to extract therefrom portions corresponding to specified subtopics and to composite the portions into a single media file for return to the client computer 210.

In this regard, the automated composition module 270 can include program code that when executed in memory of the host computing system 260 can be enabled to specify the subtopics of the topic of a query, either directly as provided in the query, or indirectly by constructing a list of subtopics present in a set of media files pertaining to the specified topic of the query. In the latter instance, meta data such as tags associated with each media file relating to the topic can be inspected in order to generate a list of available subtopics. The list can be presented in the search engine user interface and a selection of one or more of the subtopics can be processed. In the former instance, the subtopics can be specified within the body of the query itself.

The program code of the automated composition module 270 additionally can be enabled to extract from the media files pertaining to the topic, only those portions corresponding to the specified subtopics and to aggregate the extracted portions into a single media file representative of comprehensive coverage of the specified subtopics. Optionally, the program code of the automated composition module 270 can be enabled to sort the portions so that portions of a like subtopic are grouped together in the single media file. As another option, the program code of the automated composition module 270 can be enabled to filter from the portions those of the portions known to have a low rating by other end users, those of the portions having a lower frequency of views by other end users, those of the portions having a lower frequency of sharing or recommendation by other end users, or any combination thereof. As even yet another option, the program code of the automated composition module 270 can be enabled to filter from the portions those of the portions having a playback duration that exceeds a threshold value.

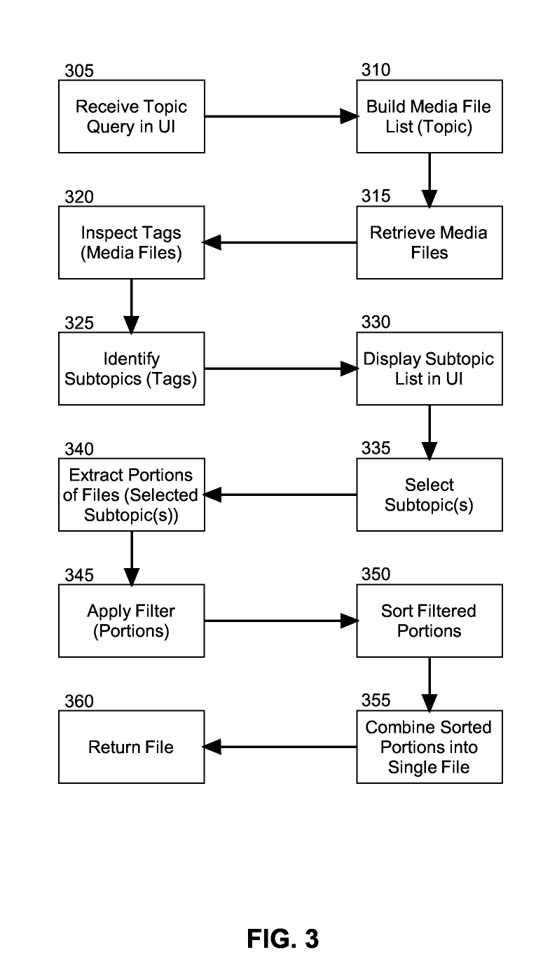

In even yet further illustration of the operation of the automated composition module 270, FIG. 3 is a flow chart illustrating a process for the automated composition of topical media. Beginning in block 305, a topic query can be received in a search engine user interface. In block 310, a media file list can be determined based upon the topic and in block 315 the media files in the list can be retrieved for processing. In block 320, the meta data of the media files can be inspected and in block 325, for each of the media files, one or more subtopics corresponding to contained portions can be identified and presented in the user interface as a comprehensive list of subtopics represented by the media files.

In block 335, one or more of the subtopics in the list can be selected. In response to the selection of the subtopics, in block 340 portions of the media files corresponding to the selected subtopics can be extracted from the media files and filtered in block 345. In this regard, those portions of the media files known to be of too low a rating, or to be too infrequently viewed, recommended or shared, can be excluded from further processing. Also, those portions of the media files known to have a playback duration that exceeds a threshold value can be excluded from further processing. Thereafter, in block 350 the remaining portions can be sorted according to like subtopic and combined in block 355 into a single media file. Finally, in block 360 the single media file can be returned to the end user in response to the query as a comprehensive view of the selected subtopics.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for the automated composition of topical media, the method comprising:
specifying a topic of interest in a search engine interface of a search engine;
searching one or more media stores over a computer communications network for media files pertaining to the specified topic;
retrieving multiple different media files including portions corresponding to the topic of interest;
compositing the portions into a single media file; and,
storing into fixed storage the single media file.

2. The method of claim 1, wherein the retrieving comprises:
additionally specifying in the search engine interface one or more subtopics of the topic of interest; and,
retrieving multiple different media files including portions corresponding to the one or more subtopics of the topic of interest.

3. The method of claim 2, wherein the portions are sorted according to common subtopic during composition into the single media file.

4. The method of claim 2, wherein for at least one subtopic only corresponding portions of a highest rating relative to other corresponding portions are included during composition while corresponding portions of a lowest rating are excluded from composition.

5. The method of claim 1, wherein only media files determined to be popular are retrieved while other media files determined not to be popular are excluded from retrieval.

6. The method of claim 5, wherein a media file is determined to be popular based upon frequency of views known for the media file, a frequency of shares for the media file, a frequency of recommends for the media file, or a rating applied to the media file.

7. The method of claim 1, wherein only portions known to be of less than a threshold playback duration are included for composition into the single media file.

8. The method of claim 2, wherein the portions of each of the media files are determined to correspond to the one or more subtopics based upon tags applied to the portions of each of the media files.

9. The method of claim 8, further comprising:
displaying in the search engine interface a list of all subtopics corresponding to each of the media files based upon the tags; and,
specifying the subtopics by selecting in the list the one or more subtopics of interest.
